(19) United States
(12) Patent Application Publication
(10) Pub. No.: US 2022/0082068 A1
(43) Pub. Date: Mar. 17, 2022

(54) Electronic fuel amplifier

(71) Applicant: Emmanouel Kalis, (US)

(72) Inventor: Emmanouel Kalis, (US)

(21) Appl. No.: 11/793,928

(22) PCT Filed: Jul. 30, 2004
(86) PCT No.: PCT/GR04/00042

§ 371 Date: Jan. 25, 2008

(30) Foreign Application Priority Data
Aug. 1, 2003 (GR) 20030100329

(51) Int. Cl. F02M 27/04; F02B 51/04; H01Q 1/46

(52) U.S. Cl. CPC F02M 27/04; H01Q 1/46; F02B 51/04

(57) ABSTRACT

An electronic fuel amplifier comprising a main body (1), containing an electronic board (5) and voltage increase transformer (6), fixed in a spot near the fuel supply tube of the engine and connected with a current supply cable (2), which is connected with the battery of the vehicle, and with a cable (3) which is wrapped round the fuel supply tube and used as antenna of transmitter (4), transmitting radiofrequencies of the ultrasonic spectrum and said radiofrequencies create an alternating electric field in the fuel with chemical results, resulting in an increase of the engine performance and reduction of fuel consumption.

### FIELD OF THE INVENTION

The present invention relates to a fuel amplifier comprising an electronic device, which includes the main body that contains the electronic mechanism and two wirings originating from the body. The device is connected with the battery of the vehicle and the petrol or oil supply tube of the vehicle.

The invented device is destined to provide reduction in the consumption of fuel, increase of the horsepower and torque of engine and reduction of exhaust emission. At the same time the device keeps the engine clean from the so-called carbonizations

### DESCRIPTION OF RELATED ART

Until today in the prior art similar devices have been manufactured with permanent magnets, placed externally and round the fuel supply tube. Said devices are destined to create an electric field through a powerful magnetic field in order to achieve the reduction of fuel consumption. The manufacture companies report that the reduction percentage is 5%. Basic disadvantage of said devices is that when the ambient temperature exceeds 80° C., their magnets cease their normal function until they revert in the regular temperature.

### SUMMARY OF THE INVENTION

The invented device achieves a reduction consumption rate of 25%, an increase of horsepower in percentage of 10% and reduction of exhaust emission up to 50%. Moreover, the function of the invented device is not based on the creation of magnetic field but creates ultrasonic frequencies and operates with electric current supplied by the battery of the vehicle. Furthermore, the invented device is not influenced by the high temperatures created in the engine of the vehicle and it excellently functions in temperatures up to 125° C., while at the same time the manufacture cost is low as materials of conventional technology are used.

An important advantage of the device of the present invention is the very low energy consumption (indicatively it is reported that half of the energy required by a car alarm is consumed). As a result the device can continuously function without a battery discharge.

Another very important advantage of the device is that the purposes of the invention are fulfilled with no use of chemical additives or fuel amelioratives the production and combustion of which pollute the environment. Therefore, the device is environment and user-friendly.

Moreover, the duration of life of the device is particularly long, approximately 10 years, and neither maintenance nor replacement of the device's fittings is required.

### BRIEF DESCRIPTION OF THE DRAWINGS

The technical, constructional and functional characteristics of the fuel amplifier device, according to the present invention, will be comprehensive to those skilled in the art, with reference to the accompanying drawings of the present specification, which show industrial preferred embodiments of the present invention.

FIG. 1 shows in proportion the main body of the device with the two cables.

FIG. 2 is a traverse vertical section of the main body of the device with the inner parts thereof.

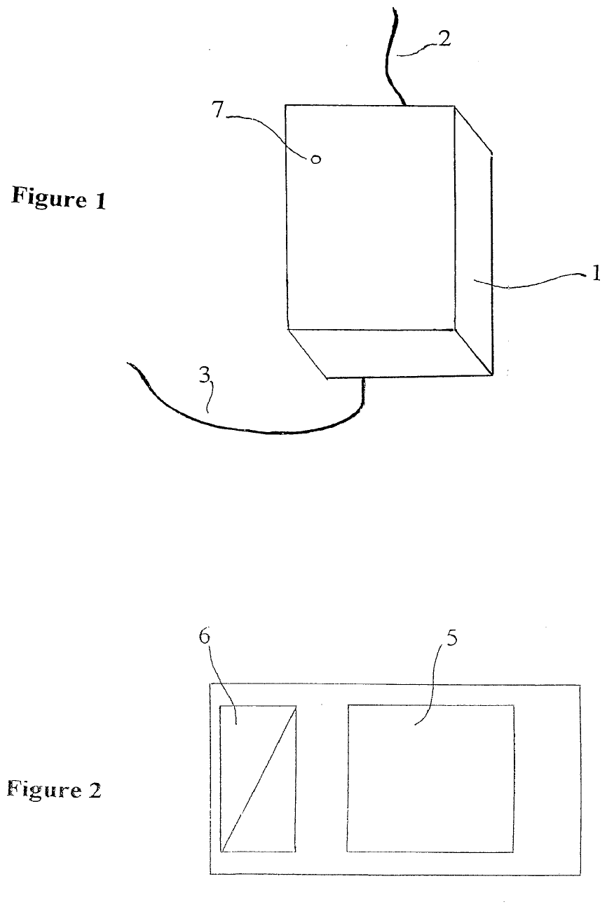

The drawings show an example of the present invention. Hereinafter, same reference numbers of the main parts of the object refer to the corresponding reference numbers of those parts in the accompanying drawings. The parts are not depicted to scale but simply in dimensions proportional to one another.

### DESCRIPTION OF THE PREFERRED EMBODIMENTS

The device can be placed with various ways round or near the fuel supply tube in the engine of the vehicle. It can be permanently installed in the engine of vehicle and the installation process is simple and it can be installed even by the vehicle driver.

According to the selected indicative embodiment of the invention, main body 1 is connected with a current supply cable 2, which is connected with the battery, and a second cable 3 which is wrapped round the fuel supply tube. Cable 3 is used as antenna of the transmitter 4, transmitting radiofrequencies in the acoustic spectrum, and said radiofrequencies create alternating electric field in the fuel.

Main body 1 contains a board 5 with electronic elements and a voltage increase transformer 6 and is fixed in a spot near the fuel supply tube. Cable 3 is wrapped 20 turns externally and round the fuel supply tube and cable 2 is electrically connected with the battery or any other system supplying the vehicle with current of 12 Volts. It can permanently remain in this place.

When the engine of the vehicle is operating, electric current of 12 Volts is supplied in the main body 1, via cable 2, which, in board 5 of the main body 1, is converted into alternating current with frequencies from 50 Hz up to 100 KHz. Transformer 6 is supplied with said alternating current, and converts it into alternating current of voltage between 20 to 2000 Volts, depending on the type of vehicle, the flow of fuel and the type of fuel (oil, petrol etc). Said current is induced in the fuel, via cable 3 which is wrapped round the fuel supply tube, creating an alternating electric field with chemical results.

This induction has the following results:

a) The drastic reduction of surface tendency of humid fuel up to 30%,
b) the fracture of chains of hydrocarbons,
c) the increase of solubility of fuel, and
d) the increase of the fuel's capacity in oxygen.

Due to the above parameters, the petrol and the fuel in general, is better sublimated and the degree of its flammability is increased.

An indicator lamp 7 is placed in the box of the main body 1 controlling the proper operation of the device. Lamp 7 is permanently turned on and indicates the regular current supply of the device, as well as that no damage has been occurred. When lamp 7 is turned off, the current supply and the device are checked.

It should also be noted that the object of the present invention should not be limited to the above described example. The accomplishment of this invention is also possible in other constructive ways, methods, fittings and machinery within the scope of the present specification.

1. A electronic fuel amplifier, characterized in that it comprises a main body 1, containing an electronic board 5 and voltage increase transformer 6 and is fixed in a spot near the fuel supply tube of the engine and is connected with a current supply cable 2, which is connected with the battery of the vehicle, and with a cable 3 which is wrapped forty times around the fuel supply tube and is used as an antenna of the transmitter 4, transmitting radiofrequencies in the acoustic spectrum of 60.000 Hz, where said radiofrequencies create an alternating electric field in the fuel causing chemical reactions and results which lead to an increase of the engine performance and reduction of fuel consumption of approximately 20% to 30% depending on the type of fuel.

2. An electronic fuel amplifier according to claim 1, characterized in that the cable—antenna 3 of the transmitter 4 consists of only one cable, it does not include a coil, it does not return to the main body of the amplifier and transmits radiofrequencies of 100% sine wave form.

3. An electronic fuel amplifier according to claim 1, characterized in that an indicator lamp 7 is placed in the main body 1 of the amplifier, controlling the regular current supply of the amplifier and indicating any damages of the device.

4. An electronic fuel amplifier according to claim 1, characterized in that when the engine is operating, electric current of 12 Volts is supplied in the main body 1, via cable 2, which, in board 5 of the main body 1, is converted into alternating current with frequencies of approximately 60 Hz, which is not affected by alterations of the temperature, where the transformer 6 is supplied with said alternating current, and converts its voltage to 1500 Volts or higher, depending on the type of vehicle, the flow and the type of fuel and where said current is induced in the fuel via cable 3 creating an alternating electric field with chemical results.

5. An electronic fuel amplifier according to claim 1, characterized in that it induces alternating current in the fuel creating an alternating electric field of 100% sine wave form, resulting in the drastic reduction of surface tendency of the liquid fuel up to 30%, the fracture of chains of hydrocarbons, the increase of solubility of fuel, the increase of the fuel's capacity in oxygen, and consequently the substantially better engine performance, save on fuel and the reduction of the emission of exhaust and gas fumes to a percentage of 80% up to 100% of the non-burnt hydrocarbons and from 80% up to 95% of NO, CO and CO₂.
